(19) United States
(12) Patent Application Publication
(10) Pub. No.: US 2013/0346582 A1
(43) Pub. Date: Dec. 26, 2013

(54) DEPLOYMENT OF SERVICES ON A SET OF REAL OBJECTS WITH AUTOMATIC MATCHING

(71) Applicants: Alain Pastor, Nozay (FR); Monique Lu, Nozay (FR)

(72) Inventors: Alain Pastor, Nozay (FR); Monique Lu, Nozay (FR)

(73) Assignee: ALCATEL LUCENT, Paris (FR)

(21) Appl. No.: 13/977,979

(22) PCT Filed: Dec. 29, 2011
(86) PCT No.: PCT/EP2011/074218

§ 371 Date: Sep. 9, 2013

(30) Foreign Application Priority Data
Jan. 10, 2011 (FR) 1150178

(51) Int. Cl. H04L 12/24

(52) U.S. Cl. CPC H04L 41/24
USPC 709/223

(57) ABSTRACT

A device for deploying a service onto an environment's set of real objects (Obj1, Obj2, Obj3), comprising means of interaction (T, TC) with a user (U) in order to select said service from among a set of available services, each available service being associated with points of interface,—means of storing representations (OWE1, OWE2, OWE3), each representation being associated with a given object from among that set and exhibiting associations between available operations and possible states for the given object,—processing means (SM) for carrying out at least one match between a point of interface associated with the service and at least one available operation contained within the representation of a real object and associated with its current state,—And activation means (LM) for deploying the at least one match by connecting the service and the real object.

The present invention relates to the Internet of things, and more specifically to the “web of things.” These relatively new concepts are the subject of various initiatives. For example, one may cite the work described on the website “www.webofthings.com” initiated by two researchers from the University of Zurich.

This “Web of things” is also described in the article by D. Guinard and V. Trifa, “Towards the web of things: Web mashups for embedded devices” in Proceedings of WWW (International World Wide Web Conferences), Madrid, Spain, 2009.

This trend towards connecting physical objects to communication networks has also been noted in the IMS Research press release dated Aug. 19, 2010: “Internet Connected Devices About to Pass the 5 Billion Milestone.”

This press release is available at the address: http://imsresearch.com/news-events/press-template.php?pr_id=1532&cat_id=108

This work regarding the “web of things” consists of transforming real-life objects into resources available via the web, which may potentially communicate with one another over it: lamps, television sets, communication terminals, household appliances, etc. may interface with the Internet and the services (or applications) available via it, thereby enabling new possibilities.

This field of research is still mostly unexplored, and only a few applications exist.

For example, one may cite the solutions from the companies Yahoo and Google, respectively “Yahoo Pipes!” and “Google Mashup Editor”. These solutions offer an environment that makes it possible to bring together different content and services drawn from applications to create a new application. However, these solutions suffer from the fact that the applications in question must be provided by the companies in question, or at least have open standard interfaces such as RSS or Atom.

Furthermore, these solutions relate to the application's design phase. They do not enable the dynamic recognition of new resources (content, services, etc.) that appear after the application is deployed. Conversely, if a resource is not available, the application created in this way can no longer function. More generally speaking, it cannot take into account any dynamic factor (meaning one related to the “runtime”.)

Another solution is the “Pachube” platform. This platform is described on the website http://www.pachube.com. The Pachube platform publishes data from real-time sensors and allows users to create applications that use this data. However, the modeling of services is highly insufficient, and it is not possible to build new applications by relying on existing services. Furthermore, the task of searching for the desired data suppliers is a burden for the user. As the number of sensors will grow, it is quickly becoming impossible to perform this task in an optimal way.

Another solution might be based on SAWSDL (Semantic annotation for WSDL and XML Schema) from the W3C (WWW Consortium). SAWSDL makes it possible to add semantics to Web services.

Here, “Web services” refers to information systems designed to support machine-to-machine interactions over a network such as the Internet. These

“Web services” are also defined by the W3C and must therefore be understood as a limiting meaning compared to the generic term “service”, particularly by introducing technical characteristics defined by the work of the W3C.

In particular, Web services are “stateless” by nature, and therefore, it is clear that their behavior cannot depend on their state.

However, in the web of things, it is essential to model objects that possess states. For this reason, an object such as a telephone, a television set, a lamp, etc. has states: off/on, off-hook/on-hook, etc. Depending on its current state, an object offers different operations.

Thus, for example, a telephone in the “on-hook” state may offer the operations “callMe” or “forward”, and in the state “off-hook” it may offer the operations “leaveMessage” and “joinCall”.

The solution WSDL, like any solution based on Web services, does not take into account an object's states, and cannot manage the availability of an operation based on different situations.

The purpose of the invention is to improve the situation by making it possible to interface services (or applications) available on a communication network such as the Internet and real objects, taking into account the possible states that the real objects may assume and the operations available depending on those states.

To do so, one object of the invention is a device for deploying a service on a set of an environment's real objects, comprising
means of interaction with the user to select that service from a set of available services, each available service being associated with points of interface,
means of storing representations, each representation being associated with a given object from the set of real objects and exhibiting associations between available operations and possible states for said given object,
processing means for carrying out at least one match between a point of interface associated with the service and at least one available operation contained within the representation of a real object and associated with a current state of the real object.
And activation means for deploying the at least one match by connecting the service and the real object.

According to embodiments of the invention, the points of interface belong to a group comprising input points, output points, and event points.

The points of interface may be either mandatory or optional. The processing means may perform the match for each of the service's mandatory points of interface.

The means of interaction may comprise a communication terminal equipped with a display means provided to present the user with at least one part of the set of available services and an input means for selecting the service from the at least one part.

The display means and the input means may be a touchscreen.

The matching may be carried out by pairing off operations and points of interface that share a keyword.

It may also be carried out by pairing off operations and points of interface that have a strong semantic correlation.

The means of interaction may additionally be provided to present the user with at least some of the matches performed, and to enable him or her to select one or more matches.

Whenever multiple matches are performed for a single point of interface, the determination of which match is to be activated may be carried out as a function of a profile of the user.

It may also be carried out as a function of the cost of each of these matches.

The invention and its benefits will become more clearly apparent in the following description, with reference to the attached figures.

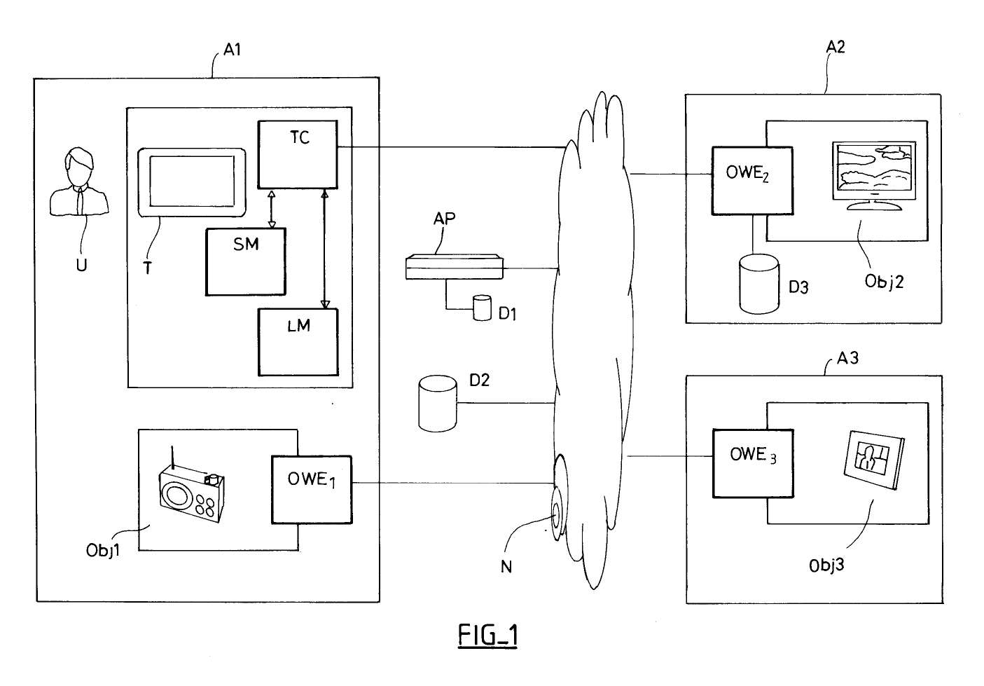

FIG. 1 illustrates the environment in which the invention is deployed.

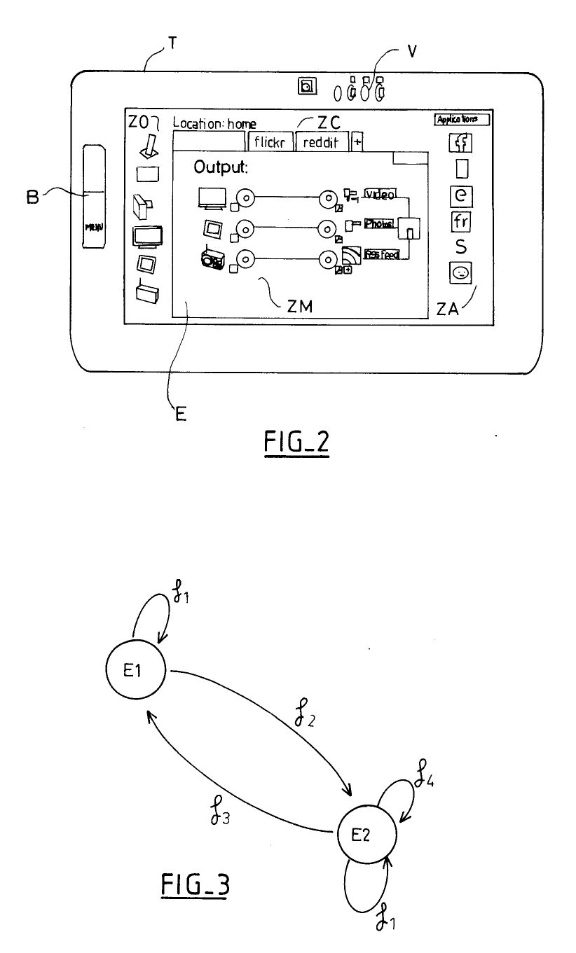

FIG. 2 illustrates one example of a human-machine interface for a dedicated terminal on which the invention may be deployed.

FIG. 3 shows a graphic view of one possible representation for a real object.

In FIG. 1, a user U uses a communication terminal T and wishes to access services and to deploy them on a set of real objects Obj1, Obj2, Obj3.

These real objects may belong to a zone shared with it. For example, the real object Obj1 is a radio that belongs to the same zone A1. They may be located in other zones. For example, the object is a television set located within a zone A2, distinct from the zone A1 in which the user U and the terminal T are located. The object Obj3 is a digital photo frame located in a third zone A3.

The notion of a zone may be based on technical considerations: an administrator may configure a set of real objects into zones based on different criteria. For example, in a semi-private building such as a hotel, different zones may correspond to different hotel rooms and to different types of common areas.

The zones may also configure themselves automatically based on predetermined criteria. They may, for example, correspond to the different rooms of an apartment.

They may be defined as the place where a certain number of real objects are gathered. They may be limited by the radio coverage of the communication devices (a “femtocell”, for example).

The different zones may be connected by a communication network N. This network may be the Internet or a private part of the Internet: an “Intranet”, a “VPN” (for “Virtual Private Network”), etc.

The communication network N thereby also makes it possible to connect with a set of available services. In the example in FIG. 1, the available services are saved in an application server AP. Naturally, different solutions are conceivable; particularly, having multiple application servers, or also having native applications on the communication terminal T itself.

The application servers may be located in the user's private network or located remotely, for example hosted by the operator, the Internet service provider (ISP), or a third-party service provider.

Means of interaction are provided to enable the user U to select a service from among those which are available.

These means of interaction therefore comprise a human-machine interface whose nature may differ. For example, it is possible to have a “voice recognition” interface enabling the user U to speak his or her choice.

It is also possible to enable the selection of the service by means of a communication terminal T. This terminal may be a mobile telephone, a computer, a personal digital assistant (or PDA) that may be a Blackberry™ or iPhone™, etc. The terminal T must in such cases include a software application that makes it possible to control the human-machine interface and communicate with the other devices of the invention.

It may also be a dedicated electronic device. FIG. 2 illustrates such a device. The invention will be described in greater detail for this example of a dedicated device, but it must be understood as applying to all types of communication terminals T.

The human-machine interface of the terminal T of FIG. 2 comprises a touchscreen E, lights V, and buttons B.

The lights V make it possible to indicate whether the device T is working or not, and potentially other state indications (connected to the network N by Wi-Fi, indication of the built-in battery's charge, etc.)

The buttons B make it possible to turn the terminal T on, and to access certain features in a fashion that complements the touchscreen E.

The touchscreen E may exhibit multiple areas. On the left, one area ZO exhibiting the various real objects available. On the right, one area ZA exhibiting the various applications available. In the center, one area ZM enabling the matches between real objects and applications. And at the top, one area ZC making it possible to view the applications that have already been deployed or to switch from one to another.

The applications (or services) that are available may be of different types. The media communications applications like Skype, content-viewing applications like Youtube, Flickr, Dailymotion, etc., social networking applications like Facebook, Myspace, Twitter, or Mixi, etc.

The invention may cover all types of existing applications possessing a human-machine interface enabling it to interact with a user. The term “service” may also be used interchangeably hereafter in the description.

These services (or applications) are associated with points of interface that enable it to interact with their environment. Typically, these points of interface belong to a group comprising input points, output points, and event points. They may be mandatory or optional. A mandatory input point indicates that data is necessary to enable the service to operate. A mandatory output point indicates that a service must provide data.

In the example of FIG. 2, three services are deployed, as indicated by the three tabs at the top: Facebook, Flickr, and Reddit. The matching area ZM depicts three output points for the service (or application) “Facebook”: one “photo” output, one “video” output, and one “RSS” output.

The user U may select a service from among those available in the right-hand section ZA, by touching it with a finger or stylus and sliding it to the central section ZM. If the screen E is not a touchscreen, other means of input are available. For example, navigation keys may be provided to move a selector through that set of displayed services.

The application area ZA may exhibit all or some of the set of services available. If there are too many of them, they may be classified into categories, and the graphical user interface may show only one category at a time, as well as means for moving from one category to another.

The associations between a service and these points of interface may be saved in the form of abstract representations. The example below illustrates one possible representation for a telephony application for people with hearing difficulties. In this example, the representation is provided in XML language (Extensible Markup Language) but other representation formats, naturally, are possible.

```
<needs>
  <resource class=“input” occur=“mandatory”>
  <event class=“ringing”/>
  </resource>
  <sequence>
  <resource class=“output” occur=“optional” kind=“light”>
    <service class=“scintillate”/>
  </resource>
  <resource class=“output” occur=“optional” kind=“text”>
    <service class=“display”/>
  </resource>
  </sequence>
</needs>
```

An example representation for the application “Facebook” may also be given:

```
<needs>
  <sequence>
  <resource class=“output” occur=“optional” kind=“display”>
    <service class=“video_stream”/>
  </resource>
  <resource class=“output” occur=“optional” kind=“display”>
    <service class=“slideshow”/>
  </resource>
  <resource class=“output” occur=“optional” kind=“sound”>
    <service class=“text_to_speech”/>
  </resource>
  </sequence>
</needs>
```

To be able to interface with existing applications in this way, it may be necessary to provide an adaptation layer suitable for using the APIs of these existing applications (for example, the API “Facebook Graph API” makes it possible to retrieve and add photos, videos, messages, etc.) or, if there is no API, to process the application's HTML representation in order to extract the output information from it (text, images, RSS feeds, etc.)

It is possible to insert the semantic representation into the HTML code. If this is done, it is beneficial to use another embodiment of the invention based on a microformat. A microformat (sometimes abbreviated μF or uF) is a Web-based data formatting approach that seeks to reuse existing content as metadata, using only_XHTML and HTML classes and attributes.

One example using such a microformat may be:

```
<div class=“needs”>
  <div class=“resource”>
  <span class=“occur”>mandatory</span>
  input
  <span class=“event”>ringing</span>
  </div>
  <div class=“sequence”>
  <div class=“resource”>
    <span class=“occur”>optional</span>
    output
    <span class=“kind”>light</span>
    <span class=“service”>scintillate</span>
  </div>
  <div class=“resource”>
    <span class=“occur”>optional</span>
    output
    <span class=“kind”>text</span>
    <span class=“service”>display</span>
  </div>
  </div>
</div>
```

These representations, which comprise at least the associations with the points of interface, may be saved within an application server AP.

This application server's nature may differ. It may be a server administered by a service company for providing one or more dedicated services.

It may also be a resource center like a “marketplace” or “applications store”, which acts as an intermediary between existing applications in order to make them compatible with the web of things.

This resource center might not host the applications themselves, but rather provide, among other things, the corresponding representations.

The terminals may implement a cache system for internally saving (or saving on a proxy) all or some of these representations, for example the ones most commonly used or the ones most recently used.

The real objects Obj1, Obj2, Obj3 are also associated with representations. These representations exhibit at least associations between available operations and possible states of the object in question.

FIG. 3 shows a graphical view of one such representation. This graphical view may be a “Petri network”, for example. It shows that the real object is associated with two states E1, E2. For each of these states, different operations on the object are available, respectively f1, f2 in state E1, and f1, f3, f4 in state E2. The same operation may be available in multiple states (f1).

This 2-state example may be a lamp that is on/off, a telephone that is on-hook/off-hook, a television that is off/on, etc.

On an abstract level, a representation may take the following form:

```
<object1>
  <state1>
        <operation1>
        <operation2>
  <state2>
  ...
</object1>
```

In more concrete terms, the representations may be given using a metadata language such as RDFa or a microformat.

RDFa is a syntax that makes it possible to describe structured data within a webpage. RDFa is the standard currently being written within W3C. It attained recommendation status on Oct. 14, 2008. These specifications are available on the website of W3C. This syntax complies with the RDF (for “Resource Description Framework”) model, and makes it possible to implement the semantic Web.

A concrete example for a lamp may be as follows:

```
    <html
          xmlns=“http://www.w3.org/1999/xhtml”
          xmlns:foaf=“http://xmlns.com/foaf/0.1/”
          xmlns:dc=“http://purl.org/dc/elements/1.1/”
          xmlns:wot-ownership=“http://wot.org/ownership#”
          xmlns:wot-core=“http://wot.org/core#”
          xmlns:wot-lifecycle=“http://wot.org/lifecycle#”
          xmlns:wot-webhook=“http://wot.org/webhook#”
          xmlns:webhook=“http://webhooks.org/spec/”
          xmlns:lamp=“http://wot.org/lamps/vocab#”>
    <body>
      <div id=“444” typeof=“lamp:TableLamp”
about=“http://somewhere.com/lamps/444”>
      <h3><a property=“wot-core:name” rel=“wot-core:self”
href=“http://somewhere.com/lamps/444”>Bob's desk lamp</a></h3>
      <div rel=“wot-ownership:owner”>Owned by <a
typeof=“foaf:Person” property=“foaf:name”
href=“http://somewhere.com/users/222”>Bob</a></div>
      <script type=“text/javascript;version=1.8” src=“restapi.js”
rev=“wot-core:api” resource=“http://somewhere.com/lamps/
444”></script>
      <div rel=“wot-lifecycle:statechart”
resource=“http://somewhere.com/lamps/444/scxml”>
        <p>The lamp's state is:
        <img src=“switch_on.png” rev=“wot-core:image”
resource=“[_:switchon]” onclick=“lamps.switchOff(444)”
style=“cursor:pointer”/>
        <p about=“http://somewhere.com/lamps/444” rel=“wot-
lifecycle:state”>
        <span typeof=“wot-lifecycle:State”
property=“wot-lifecycle:value” resource=“[_:switchon]”>
          lamp.switch.on
        </span>
        </p>
      </div>
      <div rel=“wot-core:hasOperation”>
        To <b><i><span typeof=“wot-core:Functionality” property=“wot-
core:hasName” resource=“[_:blink]”>blink</span></i></b> the lamp, you
can click on this button<br/>
        <img src=“blink.png” rev=“wot-core:api” resource=“[_:blink]”
onclick=“lamp.blink(444)” style=“cursor:pointer”/>
      </div>
      </div>
    </body></html>
```

These representations may be provided by the real objects themselves. This is because some objects may be sold with software means that allow a representation of their abilities to be provided to external devices. These representations may be different from the one described above, but different conversion mechanisms may then be provided.

The representations may also be provided by a third party or by an administrator. For some types of real objects, representation templates may also be provided, particularly being downloadable from a website. This is because, regardless of the manufacturer, a lamp, for example, may have a very standardized representation. Some parameters may potentially be modified (dimmer, spectral purity, etc.)

Adaptation devices OWE1, OWE2, OWE3 may be in charge of interfacing the real objects Obj1, Obj2, Obj3 respectively, with the communication network N. These adaptation devices may have the function of making the representations associated with each object available.

The adaptation devices may form a 1-1 association with the areas, as depicted in FIG. 1. They may also be embedded into the objects themselves; in such a case, an adaptation device is associated with a real object.

Other implementations may, however, also be conceived.

Thus, in FIG. 1, the adaptation device only interfaces with a single real object each time, but it is conceivable to have a single adaptation device for multiple real objects. This is obviously the case if a 1-1 association is maintained between area and adaptation device and if an area includes multiple real objects (which it generally does); however, it is also possible to have multiple adaptation devices within a single area and for one or more of them to interface with multiple real objects, for example based on their type, nature, or manufacturer.

The representations may be saved within a storage means. These storage means may be colocated with an adaptation device. In the event that the adaptation device is integrated into the real object, its representation may also be embedded into the memory incorporated into the object.

It is also possible to associate with the adaptation devices managing multiple real objects, a database D3 to enable it to maintain the references (and addresses) of these handled objects.

Furthermore, a centralized database D2 may be used to form a directory of the real objects. For example, whenever an adaptation device connects to the communication network, it may update that directory D2 by inserting within it the references (and potentially the addresses, characteristics, etc.) of the real objects that it manages.

The terminal control device TC is capable of searching for all or some of the available real objects. To do so, it may query the database D2. It may also query the adaptation devices OWE1, OWE2, OWE3.

The way in which the terminal control device becomes aware of the adaptation devices OWE1, OWE2, OWE3 is outside the scope of the invention. Just a few possible implementations may be mentioned here: the adaptation devices may regularly send over the communication network N messages reporting their existence and containing their address. Alternatively, they may update a registry collecting the real objects available within one area or a given larger-sized area, and their addresses.

It may also be possible for a given object to inform the terminal control device TC of the other objects of which it is aware. This implementation has the advantage of adapting to “friendly objects”: for example, an amplifier will be aware of the existence (and technical characteristics) of the DVD player, speakers, etc. to which it is normally connected.

The real objects determined in this way by the terminal control device TC may be presented on the human-machine interface of the terminal TC. (?)

In FIG. 2, the objects are presented in a graphical form within the object area ZO of the touchscreen E. From top to bottom, they are: a telephone, a medium-sized screen, a computer, a larger-sized screen (television set), a digital photo frame, and a radio.

The set of real objects may always be offered to the user U, regardless of the application selected.

However, it may also be possible to offer a filter.

This filter may be based on the type of application and on the points of interface associated with that application. For example, for a video output point, only the real objects capable of offering a video display may be proposed.

This filter may also be based on the geographic zone.

This filtering mechanism may be similar to the one that is used for automatically matching the services' points of interface and the available operations of the real objects.

The invention has processing means SM for performing at least one match between a point of interface associated with the selected service and at least one available operation contained within the representation of a real object and associated with a current state of that real object.

In more concrete terms, in the example in FIG. 2, this involves locating from among the real objects depicted in the left-hand area ZO, the objects' operations available as a function of their current states, which correspond to the three output points “video”, “photo”, “RSS” for the service “Facebook”.

This matching may be performed manually.

The user may click on one of the objects depicted in the object area ZO and drag it into the central area ZM across from the desired output point. He or she may, for example, drag the digital photo frame this way onto the “photo” or “video” output point.

The processing means may then provide any verification function, in order to check that the object selected by the user does have an operation corresponding to the interface point.

For example, it may involve verifying that the digital photo frame does have the technical characteristics to play and display videos, if it is matched with the “video” output point of the application “Facebook”.

Additionally, it may be possible to make an operation available for a selected real object, but in a different state from the current state. For example, the television is selected to display videos from the application “Facebook”, but it is off. The processing means SM may then detect this situation based on the representation associated with the “television” object, and offered to change its state in order to make the “play video” operation available. The processing means SM may determine the actions to perform on the real object in order to put it into that state; or in the “nearest” state if the object has more than one state in which the operation in question is available (the “nearest” state may be the one that requires the least action, or the least costly actions).

The processing means SM may also perform a match automatically.

This matching may be performed by pairing off operations and points interface that have a strong semantic correlation. To do so, semantic values may be assigned to the operations and points of interface, within their representations.

The real objects' representations may contain a keyword associated with each operation. This keyword may be the identifier of the operation itself, or may complement that identifier.

For the lamp, this keyword may be “blink” and be inserted into a “resource=” line.

Keywords may also be associated with the points of interface of the available services. These keywords may then be saved with the services' representations.

In the example of the service described above, this keyword is inserted into an attribute “kind”. It takes two values in this example, “light” and “text”.

This keyword may be the identifier of the point of interface itself, or may complement that identifier.

One simple implementation may consist of matching operations and points of interface that have the same keyword.

However, other mechanisms are possible in order to seek to optimize the semantic correlation between operations and point of interface.

It is also important to take various factors into account:

one semantic value may be more general than the other. For example, an operation may be “display image”, while the service has an output point “display photo”. It may be beneficial for the processing means SM to be able to determine that an image is a generalization of the concept “photo”, and that the match is possible even if the keywords are different.

Keywords may be synonyms. For example, “photo” and “photograph”, “video” and “movie”. This situation may particularly occur if equipment and services from different manufacturers are used, each one using its own vocabulary. In such cases, it may be useful to be able to bypass purely syntactical matching based on identical keywords.

A need may therefore exist to perform a finer correlation. To do so, the processing means SM may use an ontology. This ontology may be available on the web, or may be more local and delivered with the processing means SM. In the latter situation, updates may be provided in order to incorporate changes, new manufacturers, new services, new equipment, etc.

This ontology may be described in different ways, based on different models, particularly RDF schema, OWL that come from the work of the W3C.

By using an ontology, it becomes possible to make correlations between synonymous concepts (“video”, “movie”, etc.) or close ones (“image”, “photo”, etc.).

For example, the point of interface “scintillate” that is found in the examples given above may be matched with the operation “blink” from the lamp example.

The automatically offered matching may potentially be modified afterward by the user U. It is displayed in the area ZM of the terminal T, and the user U may, by the human-machine interface, select the match in order to delete, edit, or configure it.

For example, he or she may configure the resolution with which the video is to be displayed by the television screen. His or her choice may be distinct from the automatic choice.

Sometimes, the same point of interface may be matched with multiple operations.

If so, multiple options may be taken by the processing means SM:

all of the possible choices may be offered to the user via the human-machine interface of the terminal T. He or she may then select his or her choice similarly to what was described for manual matching, though with the object area ZO offering only the objects that have been automatically matched. For example, for the “video” output point of the Facebook application, the object area ZO will only show objects that can display a video: television set, computer monitor, etc. in the appropriate state (“on”).

it may be provided to use a profile of the user U. This profile may comprise preferences, particularly with respect to his or her preferred equipment. It may thereby be possible to indicate that the user U prefers to watch his or her videos on television. Otherwise (television off), he or she prefers to see them on the computer monitor. This profile may be entirely set by the user, but it may also be provided that the log of the user's choices and actions will be used to at least partially define it.

It may additionally be proposed to match a point of interface with an operation of an object that is not available in that object's current state.

This proposal may make it possible to enhance the possible choices for the user, or to propose at least one choice whenever none would otherwise be possible.

For example, if no monitor is turned on when a videophone call is made, it may be proposed to turn one on. Additionally, in order to view a video from the application “Facebook”, if only the digital photo frame's screen is on, it may be proposed to turn on a larger-sized screen such as the television set.

Once again, all of the possible choices may be offered, or just a more limited sample.

Delimitation of the choices may be carried out as a function of a profile of the user.

It may also be carried out based on a notion of cost.

This cost may take into account

the number of actions needed to put the real object in question into a state in which the operation is available;

The duration of these actions (for example, turning on a computer to display the video from an incoming videophone call might not be suitable, given the necessary boot time that this would involve)

the energy consumption incurred by each action, etc.

The table below depicts different situations that may arise for a telephony application for people with hearing difficulties, as previously described.

The right-hand column indicates 3 situations, and the left-hand column indicates matches for these situations. Only the 3 output points “Ringing”, “Blink” and “Display” mentioned above are taken into account, and only the match's real object and not the operation's is indicated, as the operation is obvious to deduce from it.

| | |
|---|---|
| Normal situation | Ringing → telephone |
| | Blink → lamp |
| | Display → TV |
| TV off | Ringing → telephone |
| | Blink → lamp |
| | Display → digital photo frame |
| TV off, telephone off-hook | Ringing → alarm clock |
| | Blink → lamp |
| | Display → digital photo frame |

The processing means SM may check that all of the mandatory points of interface are indeed matched with a real object's operation. If not, it may notify the user U that he or she must complete its configuration if the matching is manual, or that the service cannot be deployed.

Finally, the inventive device comprises activation means LM for deploying the matches made in this way, by connecting the service and the real object in question.

To do so, the activation means may communicate with the real objects directly or by means of the adaptation devices OWE1, OWE2, OWE3 by using the protocols, languages, and mechanisms that are available.

In particular, the mechanisms DPWS (for “Device Profile for Web Services”), REST (for “Representational State Transfer”), WDSL 2.0, etc. may be used.

This DPWS mechanism is particularly described in the links http://schemas.xmlsoap.org/ws/2006/02/devprof/ and http://download.microsoft.com/download/b/5/3/b53ea430-dbe5-440c-a308-df97b10280b7/introducing_dpws.pdf

Using these technologies, the activation means LM may establish the communication between the services' points of interface and the real objects' operations.

To do so, the application may use the API provided by the adaptation device OWE1, OWE2, OWE3, described in RDFa in the HTML representation that it itself provides.

Furthermore, the activation means LM may control, in real time, the availability of the objects and the state of the connections between services and real objects If the connection is interrupted, they may thereby send a message to the processing means SM so that they can trigger a new match with another real object that is available.

The activation means may maintain the relationship with the real object via the adaptation devices OWE1, OWE2, OWE3.

These devices may, for example, have a subscription mechanism to which the activation means LM may subscribe in order to be automatically informed of the real object's events. Alternatively, the activation means may regularly send requests in order to be assured that the real objects are still available.

1. A device for deploying a service onto an environment's set of real objects, comprising means of interaction with a user in order to select said service from among a set of available services, each available service being associated with points of interface,
means of storing representations, each representation being associated with a given object from among said set of real objects and exhibiting associations between available operations and possible states for said given object,
processing means for performing at least one match between a point of interface associated with said service and at least one available operation contained within the representation of a real object and associated with a current state of said real object.
and activation means for deploying the at least one match by connecting said service and said real object.

2. A device according to claim 1, wherein said points of reference belong to a group comprising input points, output points, and event points.

3. A device according to claim 1, wherein said points of interface may be either mandatory or optional, and wherein said processing means perform the match for each of said service's mandatory points of interface.

4. A device according to claim 1, wherein said means of interaction comprise a communication terminal equipped with a display means operative to present to said user at least one part of said set of available services, and an input means for selecting said service from among said at least one part.

5. A device according to claim 1, wherein said display means and said input means are a touchscreen.

6. A device according to claim 1, wherein said match is performed by pairing off operations and points interface having the same keyword.

7. A device according to claim 1, wherein each match is performed by pairing off operations and points of interface having a strong semantic correlation.

8. A device according to claim 1, wherein said means of interaction are additionally operative to present said user with at least some of said performed matches and to enable him or her to select one or more matches.

9. A device according to claim 1 wherein whenever multiple matches are performed for a single point of interface, the determination of which match is to be activated is performed as a function of a profile of said user.

10. A device according to claim 1, wherein whenever multiple matches are performed for a single point of interface, the determination of which match is to be activated is performed as a function of each of said multiple matches.
